(19) United States
(12) Patent Application Publication
(10) Pub. No.: US 2008/0201276 A1
(43) Pub. Date: Aug. 21, 2008

(54) MUSIC AND ART NETWORK

(76) Inventor: David Hadland, Lexington, KY (US)

Correspondence Address: KING & SCHICKLI, PLLC, 247 NORTH BROADWAY, LEXINGTON, KY, 40507, US

(21) Appl. No.: 12/033,429

(22) Filed: Feb. 19, 2008

Related U.S. Application Data
(60) Provisional application No. 60/890,242, filed on Feb. 16, 2007.

(51) Int. Cl. E04B 1/00; G06F 19/00; G06Q 90/00

(52) U.S. Cl. 705/500; 52/750

(57) ABSTRACT

A music and arts facility includes a campus incorporating a studio section, a video cast stage, an internet communication center and a café. The facility may also include an art gallery and a library. In addition, a method of advancing music and arts include offering membership to a network of musicians and artists and providing members of the network with access to a recording studio, a video cast stage and an internet communication center.

This application claims the benefit of U.S. Provisional Patent Application Ser. No. 60/890,242, filed on 16 Feb. 2007.

### TECHNICAL FIELD

The present invention relates generally to the field of fine arts and, more particularly, to a music and arts facility and a method of advancing music and arts.

### BACKGROUND OF THE INVENTION

In the media industry, relationships are created through networking. The majority of painters, musicians, filmmakers and designers who have the talent to achieve success are done before they start because they lack the networking skills and the wherewithal to make it happen. Thus, their genius and talent is wasted. In many communities and cities throughout the world, the music and art communities are not connected for the common good. There are small clusters of organizations that help and promote their specific craft, but not a mother or blanket organization for all.

The present invention relates to a physical facility and a related method that interconnects and networks talented painters, musicians, filmmakers, designers and the like for their benefit and as a consequence serves to advance music and the arts.

### SUMMARY OF THE INVENTION

In accordance with the purposes of the present invention as described herein, a music and arts facility is provided comprising a campus including a studio section, a video cast stage, an internet communications center and a café. The studio section may include a pre and post production studio, an internet radio studio and a film editing studio. The video cast stage is open to the café. The campus may further include an art gallery and a music and arts library if desired.

In accordance with an additional aspect of the present invention a method is provided of advancing the music and arts. The method may be broadly described as comprising the steps of offering membership to a network of musicians and artists; and providing members of the network with access to a radio studio, a video cast stage and an internet communication center.

In the following description there is shown and described several possible embodiments of the present invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical view of the novel music and arts facility of the present invention; and

FIG. 2 is a block diagram designed to help further facilitate the description of that facility, the services provided by the facility and the method of the present invention.

Reference will now be made in detail to the present preferred embodiments of the invention, examples of which are illustrated in the accompanying drawings.

### DETAILED DESCRIPTION OF THE PREFERRED EMBODIMENTS OF THE INVENTION

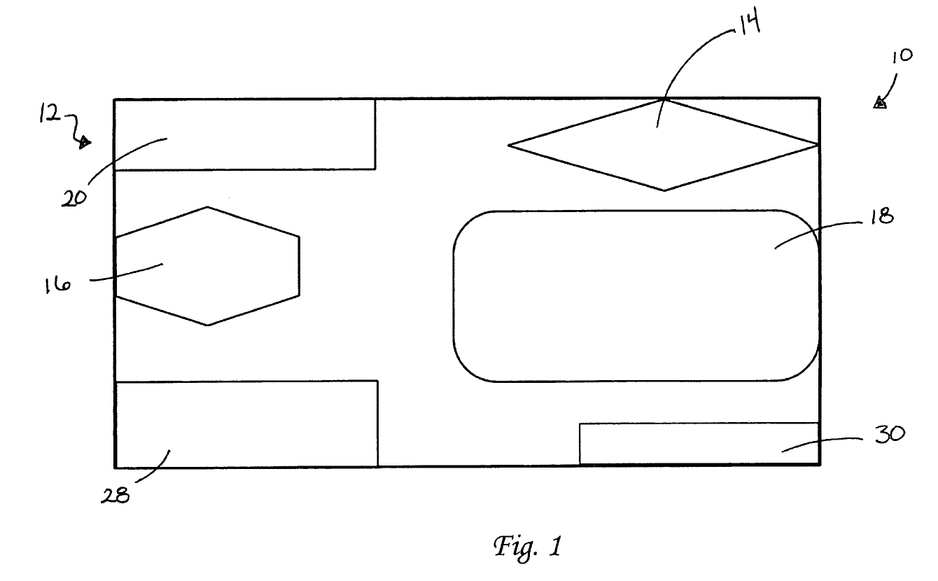

Reference is now made to FIG. 1 illustrating the novel music and art facility 10 of the present invention. The facility 10 may be described as a campus including a studio section 12, a video cast stage 14, an internet communication center 16 and a café 18. While the facility 10 is illustrated as being encompassed within a single building in FIG. 1, it should be appreciated that the campus may in fact include multiple buildings.

As further illustrated in FIG. 1, the studio section 12 may comprise a recording studio 20 consisting of a pre and post production studio 22, an internet radio studio 24 and a film editing studio 26. The pre and post production studio 22 may be utilized, for example, to record and mix different performers or musical groups. The internet radio studio 24 may be utilized to produce member shows. The film and editing studio 26 may be utilized, for example, to edit musician and rock group videos, for live performances or even for independent film editing.

As further illustrated in FIG. 1, the video cast stage 14 is open to the café 18. Thus, live performances may be presented on the video cast stage to bring musicians, artists and fans together in person, live at the café, and, for example, globally by internet broadcast. Similarly, internet shows such as “TV shows” may be presented on the video cast stage 14 with the same benefits.

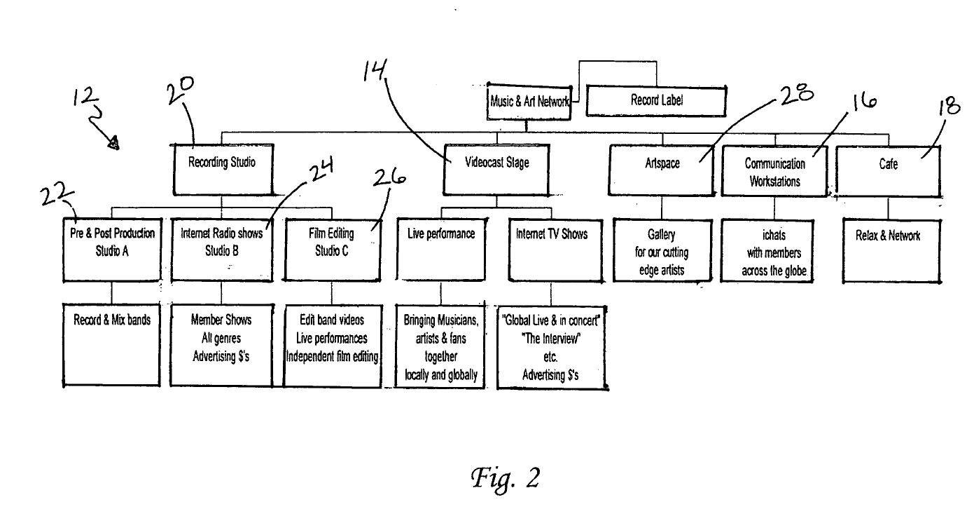

As further illustrated in FIGS. 1 and 2, the facility 10 may also include an art space 28 in the form of a gallery. This allows member artists to display their works. The facility 10 may also include a library 30 if desired. The library may include any book anticipated to be of general interest to the members of the network and facility including, but not limited to, biographical and autobiographical books about artists, musicians and the like, reference books to agents and contacts and any other appropriate subject. The internet communication center 16 allows members of the facility to communicate with others in the art world across the globe including, but not necessarily limited to, members of other networked facilities located in other communities.

The café 18 allows the members to not only relax and network but also provides an excellent atmosphere for live stage performances before an audience of member individuals, the general public or both.

The method of the present invention may be broadly described as comprising the steps of offering membership to a network of musicians and artists and providing members of that network with access to a facility 10 as described above including, for example, a recording studio 12, a video cast stage 14 and an internet communication center 16.

The method may further include the equipping of a recording studio 12 for sound recording and reproduction, film recording and reproduction and film production.

The method may further include providing a café 18 adjacent to the video cast stage 14. In addition the method may include providing members of the network with access to a music and arts library. Further, the members may be provided with access to an art gallery.

The method may also include the broadcasting of work product of the members of the network over the internet. Accordingly, the members are given the means to reach a global audience. Substantially any member work product may be broadcast including, but not limited to, recorded concerts, live concerts, films, documentaries, images, stage performances and combinations thereof.

The method also allows for the staging of live performances on the video cast stage for members of the network. Further, the method includes promoting those performances.

In accordance with additional aspects of the present invention the method includes providing the recording studio 20, the video cast stage 14 and the internet communication center 16 at a single campus. The method may also be broad reaching and even global in scope by providing members of the network with multiple campuses located in multiple cities and networking or interconnecting those campuses with two way communication. In addition the method may include the operating of a recording label for members of the network, the operating of a publishing company for members of the network and the operating of an internet based broadcast system for promoting work product for the members of the network.

Further, the method may include holding functions to introduce new members to existing members of the network. In addition, the method may include the assisting of members of the network in closing recording/publishing/merchandising contracts. Further, the method includes scheduling on-line interviews for the members of the network with industry agents and executives. These latter two steps of the method serve to help the members of the network promote their careers in the arts field.

The foregoing description of various embodiments of the invention has been presented for purposes of illustration and description. It is not intended to be exhaustive or to limit the invention to the precise forms disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A music and arts facility, comprising:
a campus including a studio section, a video cast stage, an internet communications center and a café.

2. The facility of claim 1, wherein said campus includes multiple buildings.

3. The facility of claim 1, wherein said campus is a single building.

4. The facility of claim 1, wherein said studio section includes a pre and post production studio, an internet radio studio and a film editing studio.

5. The facility of claim 4, wherein said video cast stage is open to said café.

6. The facility of claim 5, wherein said campus further includes an art gallery.

7. The facility of claim 6, wherein said campus further includes a library.

8. A method of advancing music and arts, comprising:
offering membership to a network of musicians and artists; and
providing members of said network with access to a recording studio, a video cast stage and an internet communication center.

9. The method of claim 8, further including equipping said recording studio for sound recording and reproduction, film recording and reproduction and film production.

10. The method of claim 8, further including providing a café adjacent said video cast stage.

11. The method of claim 8, further including providing members of said network with access to a music and arts library.

12. The method of claim 8, further including providing members of said network with access to an art gallery.

13. The method of claim 8, further including broadcasting work product of said members of said network over the internet.

14. The method of claim 13, wherein said work product includes recorded concerts, live concerts, films, documentaries, images, stage performances and combinations thereof.

15. The method of claim 14, further including staging live performances on said video cast stage for said members of said network.

16. The method of claim 15, further including promoting said performances.

17. The method of claim 8, further including providing said recording studio, said video cast stage and said internet communication center at a single campus.

18. The method of claim 17, further including providing said members of said network with multiple campuses located in multiple cities and interconnecting those campuses with two-way communication.

19. The method of claim 8, further including operating a recording label for said members of said network.

20. The method of claim 8, further including operating a publishing company for said members of said network.

21. The method of claim 8, further including operating an internet based broadcast system for promoting work product of said members of said network.

22. The method of claim 8, further including holding functions to introduce new members to existing members of said network.

23. The method of claim 8, further including assisting members of said network in closing a recording/publishing/merchandising contract.

24. The method of claim 8, further including scheduling on-line interviews for said members of said network with industry agents/executives.
